(19) United States
(12) Patent Application Publication
(10) Pub. No.: US 2015/0085221 A1
(43) Pub. Date: Mar. 26, 2015

(54) BACKLIGHT MODULE AND CORRESPONDING LIQUID CRYSTAL DISPLAY

(71) Applicants: Yanxue Zhang, Shenzhen (CN); Yu-chun Hsiao, Shenzhen (CN)

(72) Inventors: Yanxue Zhang, Shenzhen (CN); Yu-chun Hsiao, Shenzhen (CN)

(73) Assignee: Shenzhen China Star Optoelectronics Technology Co., Ltd., Shenzhen (CN)

(21) Appl. No.: 13/581,474

(22) PCT Filed: Jun. 8, 2012
(86) PCT No.: PCT/CN2012/076624

§ 371 Date: Aug. 28, 2012

(30) Foreign Application Priority Data
May 21, 2012 (CN) 201210157613.7

(51) Int. Cl. F21V 8/00; G02F 1/1335

(52) U.S. Cl. CPC G02B 6/0091; G02F 1/1336
USPC 349/65; 362/611

(57) ABSTRACT

The present invention relates to a backlight module and a liquid crystal display (LCD). The backlight module comprises a back plate, a light source, a light guide plate, a plastic housing and a front frame which has four straight subframes. The front frame covers an upper surface of the plastic housing and fixes a display panel by matching with the plastic housing. The front frame of the backlight module and the corresponding LCD of the present invention has a simple structure, which lowers manufacturing cost of the backlight module and reduces weight of the backlight module in the meantime.

### FIELD OF THE INVENTION

The present invention relates to the display field, and more particularly to a backlight module and a corresponding liquid crystal display (LCD) which can reduce weight of the backlight module and lower manufacturing cost of the backlight module.

### BACKGROUND OF THE INVENTION

With the rapid progress and development of display technology, the traditional cathode ray tube (CRT) is phased out gradually due to bad space utilization and huge power consumption and replaced by the compact liquid crystal display (LCD). Because LCD comprises advantages such as high display quality, low power consumption and non-radiation, it is considerably applied to communication, information or consumer electronics, such as laptop, mobile phone, personal digital assistant (PDA), digital video camera, digital camera and liquid crystal television.

Please refer to FIG. 1 and FIG. 2. FIG. 1 is a structural schematic view of a traditional LCD, and FIG. 2 is a cross-sectional view taken along the line A-A′ in FIG. 1. Mostly, the LCD comprises two parts: a backlight module and a display panel 10. The main function of the backlight module is to provide an uniform surface light source to the display panel 10. Mainly, the backlight module comprises a light guide plate 11, a light source (not shown), a plastic housing 12, a back plate 13 and a front frame 14. The light guide plate 11 has an incident surface, and the light source is arranged on one side of the incident surface. The plastic housing 12 is used to fix the light guide plate 11 and the light source to the back plate 13, so that the light from a light emitting surface of the light guide plate 11 can illuminate the display panel 10. The front frame 14 and the plastic housing 12 commonly clamp the display panel 10 to fix the display panel 10.

As shown in FIG. 1 and FIG. 2, the traditional front frame 14 is generally an integrated into one-piece. The front frame 14 is connected to the plastic housing 12 and the back plate 13 by a plurality of screws 15, and the cross section thereof is L-shaped. The front frame 14 of this type consumes more raw materials so that the manufacturing cost is higher and the weight of the backlight module is heavier.

Therefore, it is necessary to provide a backlight module and a corresponding LCD to solve the problems of traditional technology.

### SUMMARY OF THE INVENTION

The purpose of this invention is to provide a backlight module and LCD. The first frame of the backlight module comprises four straight subframes, so as to provide a simple structure to lower the manufacturing cost of the frame structure and reduce weight of the backlight module in the meantime. It solves the technical problems of higher manufacturing cost for the traditional backlight module and the corresponding LCD and heavier weight for the backlight module.

To solve the problems mentioned above, the present invention provides technical solutions, as follows:

The present invention relates to a backlight module, comprising: a back plate; a light source mounted on a the back plate and used to provide light to a corresponding display panel; a light guide plate arranged on one side of the light emitting surface of the light source and used to guide the light from the light source; a plastic housing arranged on the back plate and used to fix the light source and the light guide plate onto the back plate; and a front frame comprising four straight subframes which cover the upper surface of the plastic housing and fix the display panel by matching with the plastic housing; wherein the plastic housing has positioning portions thereon to position the front frame; and the front frame is a metallic part or a plastic part corresponding to the shape of the upper surface of the plastic housing.

According to the backlight module of the present invention, each of the subframes covers the upper surface of the plastic housing on one side of the backlight module.

According to the backlight module of the present invention, the four subframes are integrated into one-piece.

According to the backlight module of the present invention, the front frame has through holes, and the front frame is connected to the plastic housing by the through holes.

The present invention also relates to a backlight module, comprising: a back plate; a light source mounted on a the back plate and used to provide light to a corresponding display panel; a light guide plate arranged on one side of the light emitting surface of the light source and used to guide the light from the light source; a plastic housing arranged on the back plate and used to fix the light source and the light guide plate to the back plate; and a front frame comprising four straight subframes which cover the upper surface of the plastic housing and fix the display panel by matching with the plastic housing.

According to the backlight module of the present invention, the plastic housing has positioning portions thereon to position the front frame.

According to the backlight module of the present invention, the front frame is a metallic part or a plastic part corresponding to the shape of the upper surface of the plastic housing.

According to the backlight module of the present invention, each of the subframes covers the upper surface of the plastic housing on one side of the backlight module.

According to the backlight module of the present invention, the four subframes are integrated into one-piece.

According to the backlight module of the present invention, the front frame has through holes, and the front frame is connected to the plastic housing by the through holes.

The present invention also relates to a LCD, comprising: a display panel; and a backlight module, comprising: a back plate; a light source mounted on a the back plate and used to provide light to a corresponding display panel; a light guide plate arranged on one side of the light emitting surface of the light source and used to guide the light from the light source; a plastic housing arranged on the back plate and used to fix the light source and the light guide plate to the back plate; and a front frame comprising four straight subframes which cover the upper surface of the plastic housing and fix the display panel by matching with the plastic housing.

According to the LCD of the present invention, the plastic housing has positioning portions thereon to position the front frame.

The LCD of the present invention, the front frame is a metallic part or a plastic part corresponding to the shape of the upper surface of the plastic housing.

According to the LCD of the present invention, each of the subframes covers the upper surface of the plastic housing on one side of the backlight module.

According to the LCD of the present invention, the four subframes are integrated into one-piece.

According to the LCD of the present invention, the front frame has through holes, and the front frame is connected to the plastic housing by the through holes.

Compared to the traditional backlight module and the corresponding LCD, the front frame of the present invention comprises four straight subframes covering the upper surface of the plastic housing and fixing the display panel by matching with the plastic housing, so that it simplifies the structure of the backlight module, which thus lowers manufacturing cost of the backlight module and reduces weight of the backlight module in the meantime. It solves the technical problems of higher manufacturing cost for the traditional backlight module and the corresponding LCD and heavier weight for the backlight module.

For the present invention described above will be more apparent, the following specific preferable embodiment with the companying drawings will be elaborated as follows:

### DESCRIPTION OF THE DRAWINGS

FIG. 1 is a structural schematic view of a traditional LCD;

FIG. 2 is a cross-sectional view taken along the line A-A′ in FIG. 1;

FIG. 3 is a structural schematic view of a LCD of the present invention; and

FIG. 4 is a cross-sectional view taken along the line B-B′ in FIG. 3.

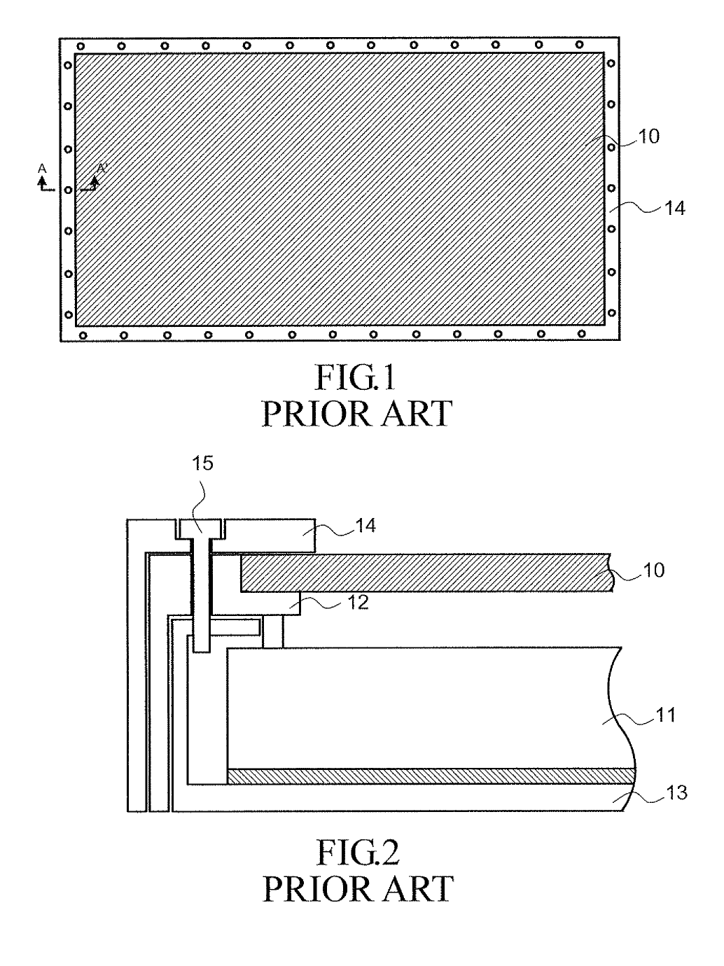

Wherein the reference numbers are illustrated as follows:

| | |
|---|---|
| 20. display panel; | 23. back plate; |
| 21. light guide plate; | 24. front frame; |
| 22. plastic housing; | 241. subframe; |
| 221. positioning portion; | 25. reflecting layer; |
| 222. upper-stage portion; | 26. optical film; |
| 223. lower-stage portion. | |

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, and etc., are only directions by referring to the accompanying drawings. Therefore, the used directional terms are used to describe and understand the present invention, but the present invention is not limited thereto.

In the figures, the similar structural units are designated by the same reference numbers.

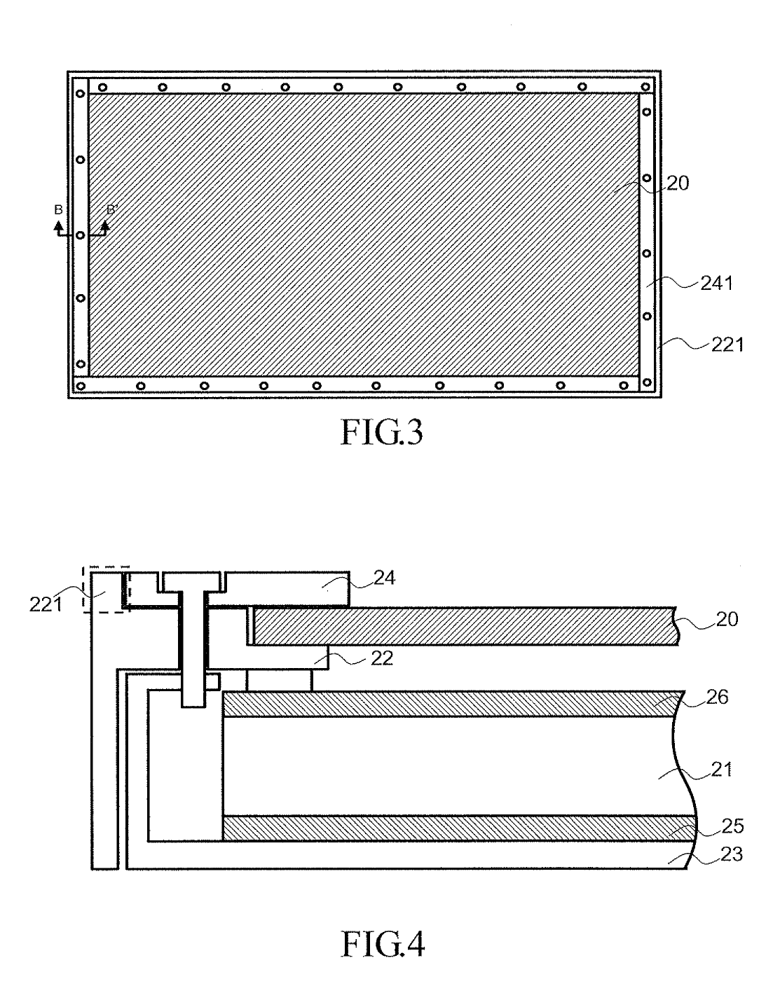

Please refer to FIG. 3 and FIG. 4, FIG. 3 is a structural schematic view of a LCD of the present invention, and FIG. 4 is a cross-sectional view taken along the line B-B′ in FIG. 3. The LCD of the present invention comprises a display panel 20 and a backlight module. The backlight module comprises a back plate 23, a light source (not shown), a light guide plate 21, a plastic housing 22 and a front frame 24. As shown in FIG. 4, the back plate 23 is arrange under the backlight module; the light source is mounted on the back plate 23 and used to provide light to the corresponding display panel 20; the light guide plate 21 is mounted on the back plate 23 as well, and arranged on one side of the light emitting surface of the light source and used to guide the light from the light source; the plastic housing 22 is arranged on the back plate 23 and used to fix the light source and the light guide plate 21 to the back plate 23; the front frame 24 comprises four straight subframes 241 which cover the upper surface of the plastic housing 22; the upper surface is outside the plastic housing 22 and parallel to the emitting surface of the display panel 20; the front frame 24 clamps and fixes the display panel 20 by matching with the plastic housing 22.

What the plastic housing 22 has from top to bottom in turn are: a flanged positioning portion 221 positioning the front frame 24, a circular upper-stage portion 222 which is relatively outside and a circular lower-stage 223 which is relative inside. The positioning portion 221 can exactly arrange the front frame 24 on the upper-stage portion 222 of the plastic housing 22 to prevent the front frame 24 from shift. The positioning portion 221 can be designed into a variety of structures, such as the flange protruding from the upper-stage portion 222 (i.e. the upper surface) of the plastic housing as shown in FIG. 4. It also can be designed into a positioning post for positioning the front frame 24 by matching with the positioning hole of the front frame 24.

The shape of the front frame 24 corresponds to the shape of the plastic housing 22 (for example, rectangular ring shaped), so that the front frame 24 can closely cover the upper-stage portion 222 of the plastic housing 22. Meanwhile, the front frame 24 has through holes, so that the front frame 24 can closely couple with the upper-stage 222 of the plastic housing 22 by screwing bolts or screws through holes. As shown in FIG. 4, the through holes can be arranged on the corresponding positions of the plastic housing 22. By the through holes of the front frame 24 and the through holes of the plastic housing 22, the front frame 24 screws to the back plate 23 to fix the front frame 24 and the plastic housing 22 together outsides the back plate 23.

The front frame 24 of the present invention can be a metallic portion or a plastic portion. If the front frame 24 is a metallic portion, it is easier to manufacture the straight metallic portion by pressing or casting for reducing the manufacturing cost of the casting mold of the front frame 24; meanwhile the consumption of metallic material can be greatly reduce for saving the manufacturing cost of the front frame 24. If the front frame 24 is a plastic portion, because its shape correspond to the upper-stage portion 222 of the plastic housing 22, it need not to manufacture the separate front-frame mode, instead the plastic-frame mold is enough to manufacture the corresponding front frame 24.

The subframes 241 of the front frame 24 of the present invention can be designed into a split combined type, as shown in FIG. 3, each of the subframes 241 covers the upper surface (i.e. the upper-stage portion 222) of the plastic housing 22 on one side of the backlight module. Thus, the subframe 241 has simple structure and is easy to be mounted. The four straight subframes 241 can be combined to form the front frame 24 with a rectangular ring shape. The four subframes 241 of the present invention can also be integrated into one-piece; the four subframes 241 are combined to form the front frame 24 with a rectangular ring shape, even though the four subframes 241 are molded once by the same mold, which simplifies the manufacture of the front frame 24.

In this embodiment, the light source can be a LED bar, which comprises a circuit board and emitting component (e.g. LED); the circuit board can be for example a printed circuit board (PCB) or flexible printed circuits (FPC), and the emitting component is arranged on the circuit board. The light source has an emitting surface used to illuminate the light guide plate 21. Preferably, the emitting surface is a plane which can for example be formed on the surface of the emitting component, and preferably the emitting surface is approximately perpendicular to the emitting direction (i.e. the incident direction of the light guide plate 21) of the light source.

In this embodiment, the light guide plate 21 can be for example a planar structure formed by injection molding, and the material can be for example UV curable resin, poly methyl methacrylate (PMMA) or polycarbonate (PC). The light guide plate 21 comprises an emitting surface, a light reflector and a side-light surface. The emitting surface is positioned in front of the light guide plate 21 and used to pass the light from the light guide 21 to the display panel 20; the light reflector is positioned on the base surface of the light guide plate 21 and opposite to the emitting surface. Each of the side-light surfaces of the light guide plate 21 is formed on one side of the light guide plate 21 or on opposite sides; the side-light surface corresponds to the emitting surface of the light source and used to pass the light from the light source into the light guide plate 21. The side-light surface is approximately perpendicular to the emitting surface.

The back plate 23 of this embodiment is formed by opaque materials such as plastic, metal or the combination of the above-mentioned materials.

Further, a reflecting layer can be arranged on the light reflector of the light guide plate 21; the reflecting layer can be for example a reflecting film or a reflecting coating with high-reflectivity materials for reflecting the light. These high-reflectivity materials can be for example silver, aluminum, gold, chromium, copper, indium, iridium, nickel, platinum, rhenium, rhodium, tin, tantalum, tungsten, manganese, alloy of any of the above combination, and white reflecting paint with yellowing resistance and heat resistance or any combination of the above-mentioned materials. It is worth notice that the reflecting surface of the light guide plate 21 also can be coated by the high-reflectivity materials to reflect the incident light, so that it can further replace and neglect the reflecting layer 25.

Meanwhile, an optical film 26can be arranged on the emitting surface of the light guide plate 21; the optical film 26 can be for example a diffusion sheet, a prism sheet, a turning prism sheet, a brightness enhancement file (BEF), a dual brightness enhancement film (DBEF), a diffused reflective polarizer film (DRPF) or a combination of any above-mentioned sheet for improving the emitting performance of the light guide plate 21.

When installing the LCD of the present invention, the light source and the light guide late are firstly arranged on the corresponding positions of the back plate 23 (arranging the reflecting layer 25 and the optical film 26 simultaneously when arranging the light guide plate 21); then a plastic housing 22 is arranged on the back plate 23, and the light source and the light guide plate 21 is fixed on the back plate 23 by the plastic housing 22; subsequently, the display panel 20 is arranged on the upper-stage portion 222 of the plastic housing 22; finally the front frame 24 (e.g. four straight subframes 241) is arrange on the upper-stage portion 222 of the plastic housing 22 by screwing, so that the front frame 24 is fixed firmly on the upper-stage portion 222 of the plastic housing 22, in the meanwhile, a space is formed by the front frame 24 and lower-stage portion 223 of the plastic housing 22 for clamping the display panel 20; the height of the clamping space is roughly equal to or smaller than the thickness of the display panel 20; the arrangement of the LCD is completed basically in this way.

The front frame of the backlight module and the LCD of the present invention comprises four straight subframes, which greatly simplifies the backlight module, especially the structure of the front frame, so that it lowers the manufacturing cost of the backlight module and reduce weight of the backlight module. Therefore, it solves the technical problems of higher manufacturing cost and heavier weight of the traditional backlight module and the corresponding LCD.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A backlight module, comprising:
a back plate;
a light source mounted on the back plate and used to provide light to a corresponding display panel;
a light guide plate arranged on one side of a light emitting surface of the light source and used to guide the light from the light source;
a plastic housing arranged on the back plate and used to fix the light source and the light guide plate onto the back plate; and
a front frame comprising four straight subframes which cover an upper surface of the plastic housing and fix the display panel by matching with the plastic housing;
wherein the plastic housing has positioning portions thereon, so as to position the front frame; and
wherein the front frame is a metallic part or a plastic part corresponding to the shape of the upper surface of the plastic housing.

2. The backlight module according to claim 1, wherein each of the subframes covers the upper surface of the plastic housing on one side of the backlight module.

3. The backlight module according to claim 1, wherein the four subframes are integrated into one-piece.

4. The backlight module according to claim 1, wherein the front frame has through holes, and the front frame is connected to the plastic housing by the through holes.

5. A backlight module, comprising:
a back plate;
a light source mounted on the back plate and used to provide light to a corresponding display panel;
a light guide plate arranged on one side of a light emitting surface of the light source and used to guide the light from the light source;
a plastic housing arranged on the back plate and used to fix the light source and the light guide plate onto the back plate; and
a front frame comprising four straight subframes which cover an upper surface of the plastic housing and fix the display panel by matching with the plastic housing.

6. The backlight module according to claim 5, wherein the plastic housing has positioning portions thereon, so as to position the front frame.

7. The backlight module according to claim 5, wherein the front frame is a metallic part or a plastic part corresponding to the shape of the upper surface of the plastic housing.

8. The backlight module according to claim 5, wherein each of the subframes covers the upper surface of the plastic housing on one side of the backlight module.

9. The backlight module according to claim 5, wherein the four subframes are integrated into one-piece.

10. The backlight module according to claim 5, wherein the front frame has through holes, and the front frame is connected to the plastic housing by the through holes.

11. A liquid crystal display (LCD), comprising:
a display panel; and
a backlight module, comprising:
a back plate;
a light source mounted on a the back plate and used to provide light to a corresponding display panel;
a light guide plate arranged on one side of the light emitting surface of the light source and used to guide the light from the light source;
a plastic housing arranged on the back plate and used to fix the light source and the light guide plate onto the back plate; and
a front frame comprising four straight subframes which cover an upper surface of the plastic housing and fix the display panel by matching with the plastic housing.

12. The LCD according to claim 11, wherein the plastic housing has positioning portions thereon, so as to position the front frame.

13. The LCD according to claim 11, wherein the front frame is a metallic part or a plastic part corresponding to the shape of the upper surface of the plastic housing.

14. The LCD according to claim 11, wherein each of the subframes covers the upper surface of the plastic housing on one side of the backlight module.

15. The LCD according to claim 11, wherein the four subframes are integrated into one-piece.

16. The LCD according to claim 11, wherein the front frame has through holes, and the front frame is connected to the plastic housing by the through holes.
